(19) United States
(12) Patent Application Publication
(10) Pub. No.: US 2009/0289953 A1
(43) Pub. Date: Nov. 26, 2009

(54) SYSTEM AND METHOD FOR ADJUSTING VIEW OF A MEASURING REPORT OF AN OBJECT

(75) Inventors: Chih-Kuang CHANG, Tu-Cheng (TW); Xin-Yuan WU, Shenzhen City (CN); Xiao-Chao SUN, Shenzhen City (CN); Jin-Bo HU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/430,111

(22) Filed: Apr. 27, 2009

(30) Foreign Application Priority Data
May 21, 2008 (CN) 200810301709.X

(51) Int. Cl. G09G 5/00; G06F 17/30

(52) U.S. Cl. 345/619; 707/104.1

(57) ABSTRACT

A computer-based method for adjusting view of a measuring report of an object is provided. The method includes defining a plurality of tolerance ranges and a unique color, and reading data of a point-cloud of the object and the triangulated surface of the object. The method further includes setting parameters to determine a user-selected position and a user-selected angle of the point-cloud and the triangulated surface in a coordinate system, and reading a nearest distance between each triangle and a nearest point in the point-cloud. Furthermore, the method includes assigning a color to each triangle according to the tolerance ranges, and outputting a measuring report of the object.

### BACKGROUND

1. Technical Field

Embodiments of the present disclosure relate to the field of computer aided design (CAD) methods, and more particularly to a system and method for adjusting view of graphical representations of an object in a measuring report.

2. Description of Related Art

Three-dimensional (3D) measurement machines are widely used to measure the shape of an object. Such 3D measurement machine measures an object according to a set of spatial coordinates of points on the object by contacting a probe on the surface of the object at those points and building a 3D graphical representation of the surface based on the coordinates. The graphic of the surface can then be compared with a designed standard surface of the object. After measurement, the 3D measurement machine outputs a 3D measuring report. The 3D measuring report includes the graphic representation coded with different colors indicating variance from the designed standard surface. Unfortunately, the viewing angle of the 3D graphic representation is fixed once it is outputted in the measuring report, making it difficult to properly analyze differences.

Therefore, there is a need for a system and method which can overcome the above-mentioned problems.

### BRIEF DESCRIPTION OF THE DRAWINGS

FIG. 1 is a block diagram of one embodiment of a system for adjusting view of a measuring report of an object.

FIG. 2 is a flowchart of one embodiment of a method for adjusting view of the measuring report of the object.

FIG. 3 illustrates one embodiment of a measuring report of the object.

### DETAILED DESCRIPTION

All of the processes described below may be embodied in, and fully automated via, function modules executed by one or more general purpose computers or processors. The code modules may be stored in any type of computer-readable medium or other computer storage device. Some or all of the methods may alternatively be embodied in specialized computer hardware.

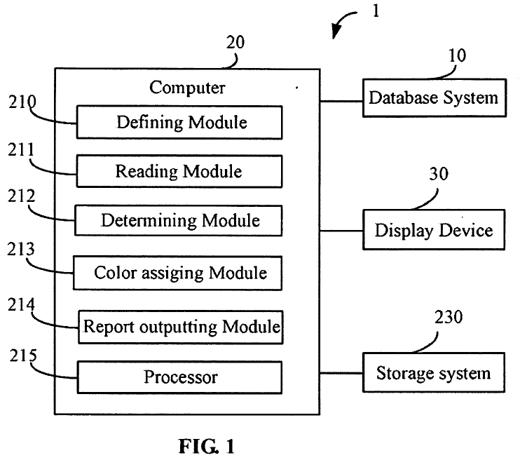

FIG. 1 is a block diagram of one embodiment of system 1 for adjusting view of a measuring report of an object. The system 1 includes a computer 20 in communication with a database system 10 and a display device 30.

The database system 10 is electronically connected to the computer 20 and is operable to store data regarding a surface of an object. It may be understood that the object is a computer aided design (CAD) model. In one embodiment, the surface may be represented by a set of dense triangles (hereinafter, referred to as “the triangulated surface”). Such data on the triangulated surface may include vertex coordinates of each triangle on the surface, vector correlations of the three vertices of each triangle, and normal vectors of each triangle. The database system 10 is further operable to store data regarding a point-cloud of the object scanned by a 3D scanner (not shown in FIG. 1). The stored data, in one embodiment, may comprise coordinates of each point in the point-cloud. In one embodiment, the point-cloud of the object is a set of vertices in a three-dimensional (3D) coordinate system and may be defined by an X, Y, Z coordinate system. The objects may be, but not limited to, a component of a mobile phone.

The display device 30 displays the triangulated surface, the point-cloud, and outputs a measuring report. A user can then view the measurement results and make informed decisions based on the measurement results.

In one embodiment, the computer 20 comprises a defining module 210, a reading module 211, a determining module 212, a color assigning module 213, and a report outputting module 214. The modules 210-214 may be stored in a storage system 230 and comprise one or more computerized operations that are executable by a processor 215.

The defining module 210 is operable to define a plurality of tolerance ranges for an area of the surface of the object having a tolerance in a predetermined range. The surface of the object comprises a triangulated surface of the object having a plurality of triangles. A unique color is further defined by the defining module 210 for distinguishing each of the tolerance ranges. For example, a color of blue-black is assigned to a first tolerance range [−0.14 mil, −0.12 mil], a color of bright-yellow is assigned to a second tolerance range [+0.12 mil, +0.14 mil]. It is noted that, in this embodiment, tolerance values between the minimum boundary value and the maximum boundary value are regarded as allowable errors.

The reading module 211 is operable to read data of the point-cloud and the triangulated surface of the object from the database system 10. In one embodiment, the data of the triangulated surface comprises coordinates of each point in the triangulated surface, and the data of the point-cloud comprise coordinates of each point in the point-cloud.

The determining module 212 is operable to set parameters to determine a position and an angle of the point-cloud and the triangulated surface in a coordinate system. In one embodiment, the parameters include a user-selected position of the coordinates and a user-selected angle for viewing the point-cloud and the triangulated surface. The determining module 212 moves the point-cloud and the triangulated surface along each axis direction of the coordinate system to a user-selected position. For example, assuming the coordinates of the user-selected position are (2, 3, 4), the determining module 212 respectively moves the point-cloud and the triangulated surface along the X-axis, Y-axis and Z-axis to the coordinates (2, 3, 4). The determining module 212 allows rotations of the point-cloud and the triangulated surface along each axis direction (e.g., X-axis, Y-axis and Z-axis) at any desired angle.

The reading module 211 is further operable to read a nearest distance between each triangle and a nearest point in the point-cloud.

The color assigning module 213 is operable to assign a color to each triangle according to the colors assigned to the tolerance ranges in which each nearest distance falls. In one embodiment, for example, if the nearest distance between a triangle and a corresponding nearest point in the point-cloud of the object falls in the tolerance range [−0.14 mil, −0.12 mil], then the color assigning module 213 assigns the color of blue-black to the triangle.

Furthermore, the reading module 211 is operable to read an outline curve of the triangulated surface.

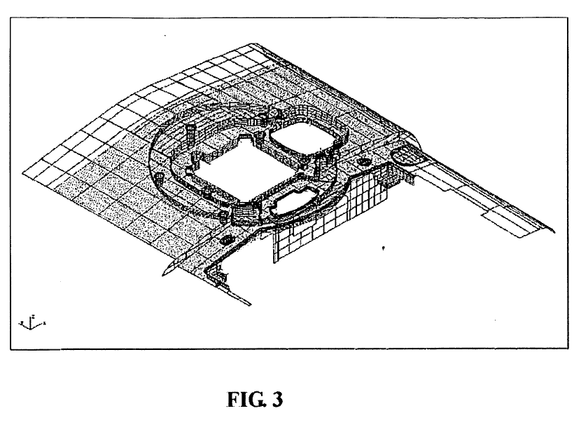

The report outputting module 214 is operable to output the measuring report. In one embodiment, the measuring report comprises the triangulated surface with the color of each triangle, and the outline curve of the triangulated surface. In one embodiment, the outputting module 214 outputs a measuring report as shown in FIG. 3. Additionally, the measuring report also contains a date, a type of the object, and a magnification when the measuring report is outputted.

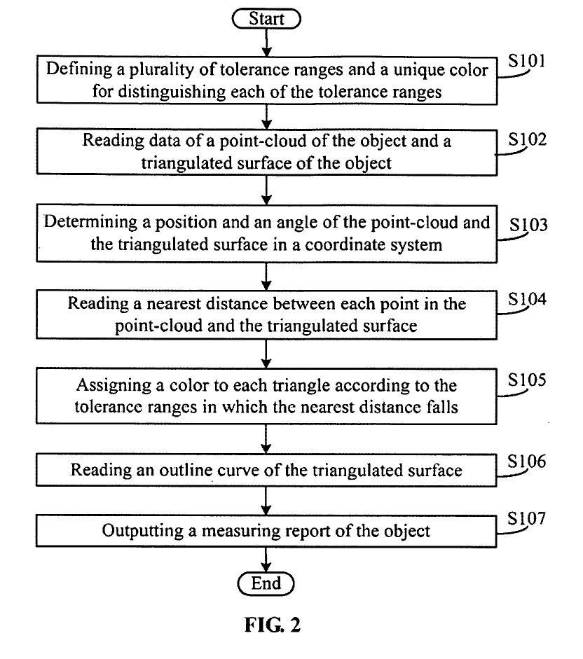

FIG. 2 is a flowchart of one embodiment of a method for adjusting view of a measuring report of an object. In block S101, the defining module 210 defines a plurality of tolerance ranges for an area of a surface of the object having a tolerance in a predetermined range and a unique color in order to distinguish each of the tolerance ranges. The surface of the object comprises a triangulated surface of the object having a plurality of triangles. As mentioned above, a color of blue-black is assigned to a first tolerance range [−0.14 mil, −0.12 mil], a color of bright-yellow is assigned to a second tolerance range [+0.12 mil, +0.14 mil].

In block S102, the reading module 211 reads data of the point-cloud and the triangulated surface of the object from the database system 10. As mentioned above, the data of the triangulated surface comprises coordinates of each point in the triangulated surface, and the data of the point-cloud of the object comprise coordinates of each point in the point-cloud.

In block S103, the determining module 212 sets parameters to determine a position and an angle of the point-cloud and the triangulated surface in a coordinate system. As mentioned above, the parameters include a user-selected position of the coordinates and a user-selected angle for viewing the point-cloud and the triangulated surface. The determining module 212 moves the point-cloud and the triangulated surface along each axis direction of the coordinate system to a user-selected position.

In block S104, the reading module 211 also reads a nearest distance between each triangle and a nearest point in the point-cloud.

In block S105, the color assigning module 213 assigns a color to each triangle according to the colors assigned to the tolerance ranges in which each nearest distance falls. As mentioned above, if the nearest distance between each triangle and a nearest point in the point-cloud of the object falls in the tolerance range [−0.14 mil, −0.12 mil], then the color assigning module 216 assigns the color of blue-black to the triangle.

In block S106, the reading module 211 further reads an outline curve of the triangulated surface.

In block S107, The report outputting module 214 outputs the measuring report of the object. The measuring report comprises the triangulated surface with the color of each triangle, and the outline curve of the triangulated surface. As mentioned above, the outputting module 214 outputs a measuring report as shown in FIG. 3. Additionally, the measuring report also contains a date, a type of the object, and a magnification when the measuring report is outputted.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for adjusting view of a measuring report of an object, the system comprising a storage system storing a plurality of programs and a processor that executes one or more operations for the plurality of programs, the programs comprising:
a defining module operable to define a plurality of tolerance ranges for an area of the surface of the object having a tolerance in a predetermined range and a unique color for distinguishing each of the tolerance ranges, wherein the surface of the object comprises a triangulated surface of the object having a plurality of triangles;
a reading module operable to read data of a point-cloud of the object and the triangulated surface from a database system;
a determining module to set parameters to determine a position and an angle of the point-cloud and the triangulated surface in a coordinate system, wherein the parameters comprise a user-selected position of the coordinates and a user-selected angle for viewing the point-cloud and the triangulated surface;
the reading module further operable to read a nearest distance between each triangle and a nearest point in the point-cloud;
a color assigning module operable to assign a color to each triangle according to the colors assigned to the tolerance ranges in which each nearest distance falls;
the reading module further operable to read an outline curve of the triangulated surface; and
a report outputting module operable to output a measuring report of the object, wherein the measuring report comprises the triangulated surface with the color of each triangle, and the outline of the triangulated surface.

2. The system of claim 1, wherein the data of the point-cloud comprise a coordinate of each point in the point-cloud.

3. The system of claim 1, wherein the reading module further reads a type of the object.

4. The system of claim 3, wherein the measuring report further comprises the type of the object and a date of the measuring report.

5. A computer-based method for adjusting view of a measuring report of an object, the method comprising:
(a) defining a plurality of tolerance ranges for an area of the surface of the object having a tolerance in a predetermined range and a unique color for distinguishing each of the tolerance ranges, wherein the surface of the object comprises a triangulated surface of the object having a plurality of triangles;
(b) reading data of a point-cloud of the object and the triangulated surface;
(c) setting parameters to determine a position and an angle of the point-cloud and the triangulated surface in a coordinate system, wherein the parameters comprise a user-selected position of the coordinates and a user-selected angle for viewing the point-cloud and the triangulated surface;
(d) reading a nearest distance between each triangle and a nearest point in the point-cloud;
(e) assigning a color to each triangle according to the colors assigned to the tolerance ranges in which each nearest distance falls;
(f) reading an outline curve of the triangulated surface; and
(g) outputting a measuring report of the object, wherein the measuring report comprises the triangulated surface with the color of each triangle, and the outline of the triangulated surface.

6. The method of claim 5, wherein the data of the point-cloud comprise a coordinate of each point in the point-cloud.

7. The method of claim 6, wherein the block of (f) further comprises:
reading a type of the object.

8. The method of claim 7, wherein the measuring report further comprises the type of the object and a date of the measuring report.

9. A computer-readable medium having stored thereon instructions for that, when executed by a computer, causing the computer to perform a method for adjusting view of a measuring report of an object, the method comprising:
(a) defining a plurality of tolerance ranges for a surface of the object and a unique color for distinguishing each of the tolerance ranges, wherein the surface of the object comprises a triangulated surface having a plurality of triangles;
(b) reading data of a point-cloud of the object and the triangulated surface;
(c) setting parameters to determine a position and an angle of the point-cloud and the triangulated surface in a coordinate system, wherein the parameters comprise a user-selected position of the coordinates and a user-selected angle for viewing the point-cloud and the triangulated surface;
(d) reading a nearest distance between each triangle and a nearest point in the point-cloud;
(e) assigning a color to each triangle according to the color assigned to the tolerance range in which each nearest distance falls;
(f) reading an outline curve of the triangulated surface; and
(g) outputting a measuring report of the object, wherein the measuring report comprises the triangulated surface with the color of each triangle, and the outline of the triangulated surface.

10. The medium of claim 9, wherein the data of the point-cloud comprise a coordinate of each point in the point-cloud.

11. The medium of claim 9, wherein the block (f) in the method further comprises:
reading a type of the object.

12. The medium of claim 11, wherein the measuring report further comprises the type of the object and a date of the measuring report.
